(19) United States
(12) Patent Application Publication
(10) Pub. No.: US 2024/0319546 A1
(43) Pub. Date: Sep. 26, 2024

(54) DISPLAY PANEL AND DISPLAY DEVICE

(71) Applicant: BOE TECHNOLOGY GROUP CO., LTD., Beijing (CN)

(72) Inventor: Chengtan ZHAO, Beijing (CN)

(21) Appl. No.: 18/027,974

(22) PCT Filed: Mar. 30, 2022
(86) PCT No.: PCT/CN2022/084085

§ 371 Date: Mar. 23, 2023

(51) Int. Cl. G02F 1/1339; G02F 1/1333; G02F 1/1335; G02F 1/1343; G02F 1/1362; G02F 1/1368

(52) U.S. Cl. CPC G02F 1/13398; G02F 1/133357; G02F 1/133514; G02F 1/134309; G02F 1/136286; G02F 1/1368

(57) ABSTRACT

The present disclosure provides a display panel and a display device. The display panel includes a plurality of pixel regions and a space region between adjacent pixel regions, the display panel includes an array substrate and a color filter substrate arranged opposite to each other, and a plurality of supporting structures arranged between the array substrate and the color filter substrate, the supporting structures are positioned in the space region; each supporting structure includes a spacer pillar arranged on the color filter substrate and a supporting part arranged on the array substrate, the spacer pillar is supported by the supporting part; at least one spacer pillar and/or at least one supporting part has a groove.

### TECHNICAL FIELD

The present disclosure relates to the field of display technology, and in particular to a display panel and a display device.

### BACKGROUND

A liquid crystal display panel is formed by filling liquid crystal between an array substrate and a color filter substrate, and aligning and combining the array substrate with the color filter substrate to form a cell. In order to maintain a stability of the liquid crystal display panel and uniformity of a thickness of the cell, spacers are generally disposed between the array substrate and the color filter substrate (i.e., a counter substrate).

### SUMMARY

The present disclosure provides a display panel and a display device.

In a first aspect, the present disclosure provides a display panel including a plurality of pixel regions and a space region between adjacent pixel regions, the display panel includes an array substrate and a color filter substrate which are arranged opposite to each other, and a plurality of supporting structures are arranged between the array substrate and the color filter substrate, the supporting structures are positioned in the space region; each of the supporting structures includes a spacer pillar arranged on the color filter substrate and a supporting part arranged on the array substrate, and the spacer pillar is supported by the supporting part; at least one spacer pillar and/or at least one supporting part has a groove.

In some implementations, the array substrate includes a first base, a plurality of gate lines and a plurality of data lines, the gate lines and the data lines are arranged on the first base and are positioned in the space region; orthographic projections of the supporting structures on the first base are positioned in orthographic projections of the gate lines and/or the data lines on the first base.

In some implementations, orthographic projections of the spacer pillar and the supporting part corresponding to each other on the first base form a first intersection region, and orthographic projections of the gate lines and the data lines on the first base form a second intersection region; the first intersection region at least partially overlaps the second intersection region.

In some implementations, at least one spacer pillar has a first groove with an opening facing the supporting part corresponding to the spacer pillar.

In some implementations, the first groove penetrates through the spacer pillar in a thickness direction of the display panel.

In some implementations, at least one supporting part has a second groove having an opening facing the spacer pillar corresponding to the supporting part.

In some implementations, the second groove penetrates through the supporting part in a thickness direction of the display panel.

In some implementations, at least one spacer pillar has a first groove, an orthographic projection of the first groove on the array substrate runs through an orthographic projection of the spacer pillar on the array substrate.

In some implementations, at least one supporting part has a second groove, an orthographic projection of the second groove on the array substrate runs through an orthographic projection of the supporting part on the array substrate.

In some implementations, at least one spacer pillar has a first groove and at least one supporting part has a second groove, an orthographic projection of the first groove on the array substrate is partially overlapped with an orthographic projection of the second groove on the array substrate.

In some implementations, the orthographic projection of the first groove on the array substrate is a first stripe pattern, the orthographic projection of the second groove on the array substrate is a second stripe pattern, the first strip pattern and the second strip pattern extend in a same direction; or, the first stripe pattern and the second stripe pattern extend in different directions.

In some implementations, an orthographic projection of at least one groove on the array substrate is bent.

In some implementations, the array substrate includes a thin film transistor, a planarization layer and a pixel electrode disposed on the first base, the planarization layer is positioned on a side of the thin film transistor away from the first base, and the pixel electrode is connected with a drain of the thin film transistor through a via hole in the planarization layer; an orthographic projection of each supporting structure on the first base at least partially overlaps with an orthographic projection of the via hole on the first base.

In some implementations, the color filter substrate includes a second base and a black matrix on the second base, the black matrix is located in the space region, and the spacer pillar is located on a side of the black matrix away from the second base, and an orthographic projection of black matrix on the second base covers an orthographic projection of spacer pillar on the second base.

In some implementations, the display panel further includes a first alignment layer and a second alignment layer, the first alignment layer is positioned on a side of the color filter substrate facing the array substrate; the second alignment layer is positioned on a side of the array substrate facing the color filter substrate; an orthographic projection of the spacer pillar on the array substrate is not overlapped with an orthographic projection of the first alignment layer on the array substrate, an orthographic projection of the supporting part on the array substrate is not overlapped with an orthographic projection of the second alignment layer on the array substrate.

In some implementations, a material of each supporting structure includes an elastomeric material.

In some implementations, a material of the supporting part includes an inorganic material and an organic material.

In some implementations, at least one spacer pillar has a first groove, a ratio of a volume of the first groove to an entire volume of the spacer pillar ranges from 10% to 90%; at least one supporting part has a second groove, and a ratio of a volume of the second groove to an entire volume of the supporting part ranges from 10% to 90%.

In some implementations, each pixel region is a rectangular region, and a ratio of a length of a short side of the rectangular region to a width of the space region ranges from 2.1:1 to 8.5:1.

In some implementations, the length of the short side of each pixel region ranges from 4.2 μm to 17 μm.

In a second aspect, the present disclosure provides a display device, including the display panel described in the first aspect.

### DESCRIPTION OF DRAWINGS

The accompanying drawings, which are included to provide a further understanding of the present disclosure and are incorporated in and constitute a part of this specification, illustrate implementations of the present disclosure and together with the description serve to explain the present disclosure, but do not constitute a limitation of the present disclosure. In the drawings:

FIG. 1 is a schematic structural diagram of a display panel according to the present disclosure;

FIG. 2 is a plan structure diagram of a display panel according to the present disclosure;

FIG. 3A is a plan structure view of orthographic projections of a spacer pillar and a signal line on a first base according to the present disclosure;

FIG. 3B is a plan structure view of orthographic projections of a supporting part and a signal line on a first base according to the present disclosure;

FIG. 4A is a plan structure view of an orthographic projection of a spacer pillar on a first base according to the present disclosure;

FIG. 4B is a plan structure view of an orthographic projection of a supporting part on a first base according to the present disclosure;

FIGS. 5A and 5B are schematic structural views of another display panel according to the present disclosure;

FIGS. 6A to 6C are plan structure views of an orthographic projection of a spacer pillar on an array substrate according to the present disclosure;

FIGS. 7A to 7C are plan structural views of an orthographic projection of a supporting part on an array substrate according to the present disclosure;

FIGS. 8A and 8B are plan structure views of an orthographic projection of a spacer pillar or a supporting part on an array substrate according to the present disclosure; and

FIG. 9 is a schematic structural diagram of another display panel according to the present disclosure.

### DETAILED DESCRIPTION

The following detailed description of the present disclosure refers to the accompanying drawings. It should be understood that the detailed description and specific examples, while indicating the present disclosure, are given by way of illustration and explanation only, not limitation.

To make objects, technical solutions and advantages of the present disclosure more apparent, embodiments of the technical solutions of the present disclosure will be clearly and completely described below with reference to the drawings. It is to be understood that the described embodiments are only a few embodiments of the present disclosure, and not all embodiments. All other embodiments, which can be derived by a person skilled in the art from the described embodiments of the disclosure without creative effort, are within the protection scope of the present disclosure.

Unless otherwise defined, technical or scientific terms used in the embodiments of the present disclosure should have the ordinary meaning as understood by one of ordinary skill in the art to which the present disclosure belongs. The use of “first,” “second,” and the like in the present disclosure is not intended to indicate any order, quantity, or importance, but rather is used to distinguish one element from another. Similarly, the word “comprising/including” or “comprises/includes”, and the like, means that the element or item preceding the word contains the element or item listed after the word and its equivalent, but does not exclude other elements or items. The terms “connected” or “coupled” and the like are not restricted to physical or mechanical connections, but may include electrical connections, whether direct or indirect. Terms “upper/on/above”, “lower/below/under”, “left”, “right”, and the like are used only to indicate relative positional relationships, and if an absolute position of the object being described is changed, the relative positional relationships may be changed accordingly.

With the rapid development of display technology, Augmented Reality (AR) technology and Virtual Reality (VR) technology have attracted extensive attention in the market and are gradually becoming leading technologies in the field of display technology. The AR/VR technology has high expectations for a display device, especially for characteristics of ultra-high resolution, ultra-high refresh frequency, and ultra-fast response.

In order to meet the expectations of the AR/VR technology for ultra-high resolution of a display panel, a support of high pixel density (Pixels Per Inch, PPI) technology is desired. In a display panel with high PPI, with the increase of the pixel density, each pixel region is reduced, and a space between adjacent pixel regions is also reduced. In order to maximize an aperture ratio of the display panel, it is desired to minimize a cross-sectional area of a black matrix and a cross-sectional area of a supporting structure disposed on the black matrix.

In addition, the AR/VR technology also expects that the display panel has an ultra-fast response speed, and an increasing of the response speed mainly depends on a reduction of a cell thickness of the display panel, so that a height of the supporting structure is desired to be correspondingly reduced.

For example, for a display panel with 1500 PPI, the cell thickness thereof is usually less than 2 μm, a length of a short side of each pixel region is reduced to be within 5 μm to 7 μm, a width of a space region between adjacent pixel regions is less than 5 μm, and a size of the black matrix in the space region is reduced correspondingly, in such case, for a supporting pillar on the black matrix, a size of a top end face of the supporting pillar away from the black matrix ranges only from 1 μm to 2 μm, and a size of a bottom end face of the supporting pillar close to the black matrix ranges only from 2 μm to 3 μm, each end face is rectangular, the size of each end face is a length of a long side thereof, and in response to that the end face is circular, the size of each end face is a diameter thereof; in addition, in a case where the cell thickness is less than 2 μm, the height of the supporting pillar is also less than 2 μm.

In the case that each of the size and the height of the end surface of the supporting pillar is reduced to about 2 μm, a supporting force of the supporting pillar is also reduced, and it is difficult to satisfy an expectation of the display panel for stability of supporting.

In order to solve at least one of above technical problems, an embodiment of the present disclosure provides a display panel, which can ensure a supporting effect thereof while reducing the size of the supporting structure.

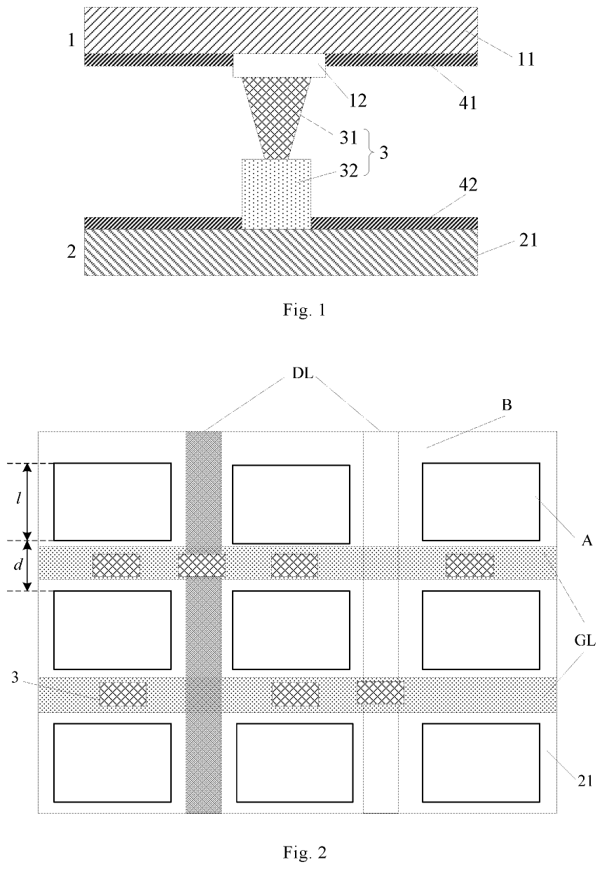

FIG. 1 is a schematic structural diagram of a display panel according to the present disclosure, as shown in FIG. 1, the display panel includes a plurality of pixel regions and a space region located between adjacent pixel regions, where the display panel includes a color filter substrate 1, an array substrate 2, and a plurality of supporting structures 3 and a liquid crystal layer (not shown) between the color filter substrate 1 and the array substrate 2. The array substrate 2 and the color filter substrate 1 are arranged opposite to each other.

The supporting structures 3 are located in the space region. Each of the supporting structures 3 includes a spacer pillar 31 arranged on the color filter substrate 1 and a supporting part 32 arranged on the array substrate 2, the spacer pillar 31 is supported by the supporting part 32; at least one spacer pillar 31 and/or at least one supporting part 32 has a groove.

The supporting structure 3 includes two parts including the spacer pillar 31 and the supporting part 32, which avoids a situation that in a case where the spacer pillar 31 serves as the supporting structure independently, the spacer pillar 31 with a relatively small size cannot provide sufficient support force, and improves the stability of the supporting structure 3. Furthermore, at least one spacer pillar 31 and/or at least one supporting part 32 has a groove, which can make the supporting structure 3 have higher elasticity, so that the display panel can be stably supported.

The plurality of supporting structures 3 are disposed at intervals in the display panel, that is, they are discontinuous in the pixel regions, and thus do not affect flowing of liquid crystal between the color filter substrate 1 and the array substrate 2.

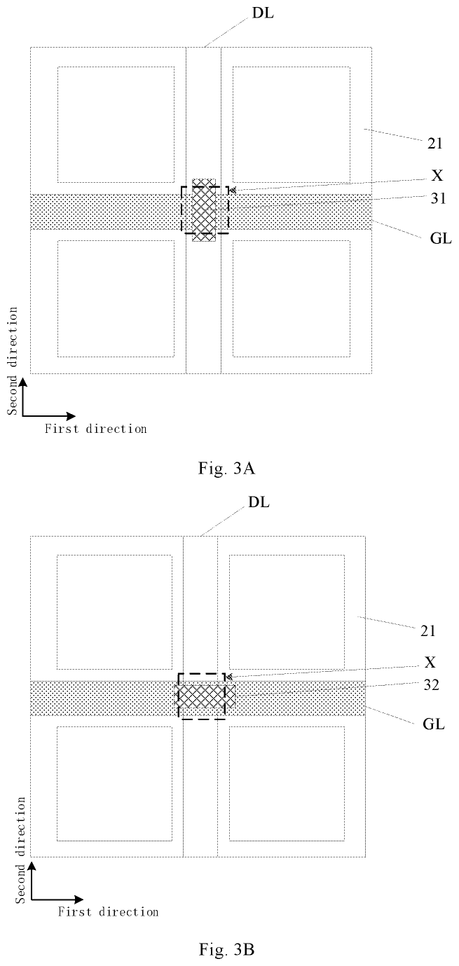

In addition, the supporting structure provided in the present disclosure is particularly suitable for the display panel with high PPI, and the display panel with high PPI may refer to a display panel having a pixel density greater than 500. FIG. 2 is a plan structure view of a display panel according to the present disclosure, in some implementations, as shown in FIG. 2, the plurality of pixel regions A of the display panel are arranged in an array, each pixel region A is a rectangular region, a long side of the rectangular region extends along a row direction, and a short side of the rectangular region extends along a column direction. In the display panel with high PPI, a ratio of a length 1 of the short side of the rectangular region to a width d of the space region B ranges from 2.1:1 to 8.5:1. The width of the space region B between any two adjacent pixel regions A in a same column refers to a size of the space region B in the column direction; the width of the space region B between any two adjacent pixel regions A in a same row refers to a size of the space region B in the row direction.

In an example, the PPI of a display panel is 500, and in such case, the length 1 of the short side of the pixel region A is about 17 μm; in a case where the PPI of the display panel is 1000, the length 1 of the short side of the pixel region A is about 5.6 μm; in a case where the PPI of the display panel is 2000, the length 1 of the short side of the pixel region A is about 4.2 μm. Typically, in a display panel with high PPI, the width of the space region is about 2 μm. The length 1 of the short side of the pixel region A and the width d of the space region B in each above example may also be other sizes, which is not limited in the present disclosure.

In some implementations, as shown in FIG. 2, the array substrate 2 includes a first base 21 and a plurality of signal lines, the signal lines may include a plurality of gate lines GL and a plurality of data lines DL. The plurality of gate lines GL and the plurality of data lines DL are disposed on the first base 21 and positioned in the space region; orthographic projections of the supporting structures 3 on the first base 21 are within orthographic projections of the gate lines GL and/or the data lines DL on the first base 21.

The gate lines GL and the data lines DL each may be made of a single-layer metal, such as Cu, or may be made of multi-layer metals, such as MO/Cu/MO, which is not limited in the present disclosure.

In order to maximize an aperture ratio of the display panel with high PPI, the orthographic projections of the supporting structures 3 on the first base 21 are disposed within the orthographic projections of the signal lines on the first base 21, so as to avoid affecting light output amount of the display panel. In addition, the spacer pillar 31 and/or the supporting part 32 in each supporting structure 3 may be increased in size along an extending direction, in which the signal lines each extend, as much as possible to provide stronger supporting force.

It should be noted that an orthographic projection of the spacer pillar 31 or the supporting part 32 of the supporting structure 3 on the first base 21 may be rectangular as shown in FIG. 2, or may be circular, square, trapezoid, or the like, which is not limited in the present disclosure.

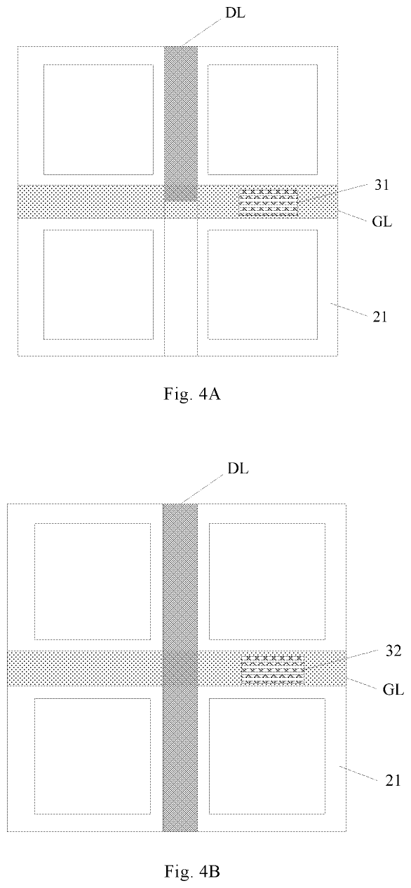

FIG. 3A is a plan structure view of an orthographic projection of a spacer pillar and a signal line on a first base according to the present disclosure, and FIG. 3B is a plan structure view of an orthographic projection of a supporting part and a signal line on a first base according to the present disclosure. In some implementations, as shown in FIGS. 3A and 3B, the orthographic projection of the spacer pillar 31 on the first base 21 and the orthographic projection of the supporting part 32 on the first base 21 form a first intersection region, and the orthographic projection of each gate line GL on the first base 21 and the orthographic projection of the data line DL, corresponding to the gate line GL, on the first base 21 form a second intersection region X; the first intersection region at least partially overlaps the second intersection region X. Each supporting structure 3 is disposed in the intersection region in which the gate line GL and the data line DL intersect, which is not only beneficial to improving the aperture ratio of the display panel, but also provides a larger space for the supporting structure 3, so that the supporting structure can provide a more stable supporting force.

In an example, as shown in FIGS. 3A and 3B, the gate lines GL each extend in a first direction, and the data lines DL each extend in a second direction. It should be noted that any signal line extending in a certain direction does not mean that the signal line is a straight line, but the signal line generally tends to extend in the certain direction. The spacer pillar 31 may be arranged at a position where the data line DL is located, so that the orthographic projection of the spacer pillar 31 on the first base 21 is located in the orthographic projection of the data line DL on the first base 21, and a long side of the orthographic projection of the spacer pillar 31 extends along the second direction; the supporting part 32 is disposed at a position where the gate line GL is located, so that the orthographic projection of the supporting part 32 on the first base 21 is located within the orthographic projection of the gate line GL on the first base 21, a long side of the orthographic projection of the supporting part 32 extends along the first direction, and the first intersection region and the second intersection region X at least partially overlap. That is to say, on one hand, the spacer pillar 31 and the supporting part 32 intersect to form an intersection structure, and in a case where the spacer pillar 31 and/or the supporting part 32 are misaligned due to a force applied on the display panel, with the intersection structure, the spacer pillar 31 and the supporting part 32 can be prevented from being completely misaligned, so as to ensure the stability of the supporting structure 3; on the other hand, the second intersection region X is an intersection region in which orthographic projections of the gate line GL and the data line DL corresponding to each other on the first base 21 intersect, which provides a larger space for the supporting structure 3, and is beneficial to realizing a maximization of the supporting structure 3, so as to improve the supporting effect.

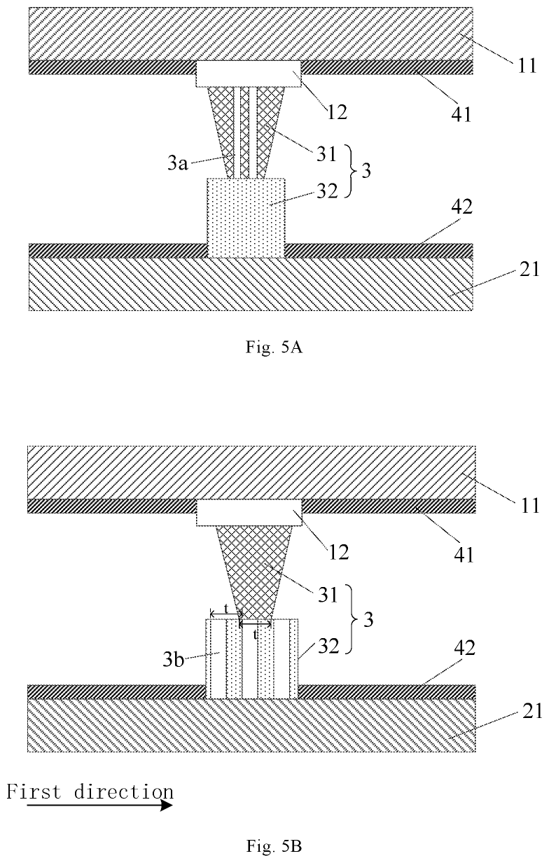

FIG. 4A is a plan structure view of an orthographic projection of a spacer pillar on a first base according to the present disclosure, and FIG. 4B is a plan structure view of an orthographic projection of a supporting part on a first base according to the present disclosure. In some implementations, as shown in FIG. 4A, at least one spacer pillar 31 has a first groove 3a, the first groove 3a having an opening toward the supporting part 32. As shown in FIG. 4B, at least one supporting part 32 has a second groove 3b, and the second groove 3b has an opening facing the spacer pillar 31.

In some implementations, a ratio of a volume of the first groove 3a to an entire volume of the spacer pillar 31 ranges from 10% to 90%; and a ratio of a volume of the second groove 3b to an entire volume of the supporting part 32 ranges from 10% to 90%.

The volume of the first groove 3a is a volume occupied by an entire hollowed-out portion in the spacer pillar 31, and the entire volume of the spacer pillar 31 is an entire volume of a space surrounded by an outer contour of the spacer pillar 31, that is, a sum of volumes of a solid portion of the spacer pillar 31 and the groove. A size (including a length and a width) of the first groove 3a may be adjusted as desired; similarly, a size of the second groove 3b may also be adjusted as desired, which is not limited in the present disclosure.

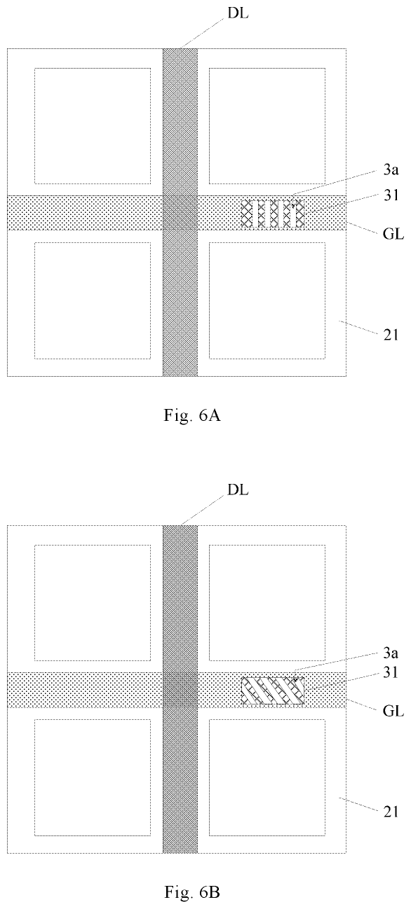

FIGS. 5A and 5B are schematic structural diagrams of another display panel according to the present disclosure, in an example, as shown in FIG. 5A, the first groove 3a penetrates through the spacer pillar 31 in a thickness direction of the display panel (in which a thickness of the display panel extends); as shown in FIG. 5B, the second groove 3b penetrates through the supporting part 32 in the thickness direction of the display panel to increase a volume of the hollow portion and improve the elasticity of the supporting structure 3.

In an example, as shown in FIG. 5B, the supporting part 32 has a plurality of second grooves 3b therein, the plurality of second grooves 3b are arranged in the first direction, and are arranged periodically in a period t; a size of an end face of the spacer pillar 31 facing the array substrate in the first direction is also t, and in a case where the spacer pillar 31 and the supporting part 32 are misaligned due to a pressure on the display panel, the supporting part 32 still can at least partially support the spacer pillar 31. That is, even if there is a misalignment between the spacer pillar 31 and the supporting part 32, a contact area therebetween can be kept constant, thereby ensuring the uniformity of the cell thickness and the stability of the supporting structure.

In another example, the first groove 3a may not penetrate through the spacer pillar 31, and the second groove 3b may not penetrate through the supporting part 32, and the size of each groove may be flexibly adjusted according to an expectation on the elasticity of the supporting structure 3.

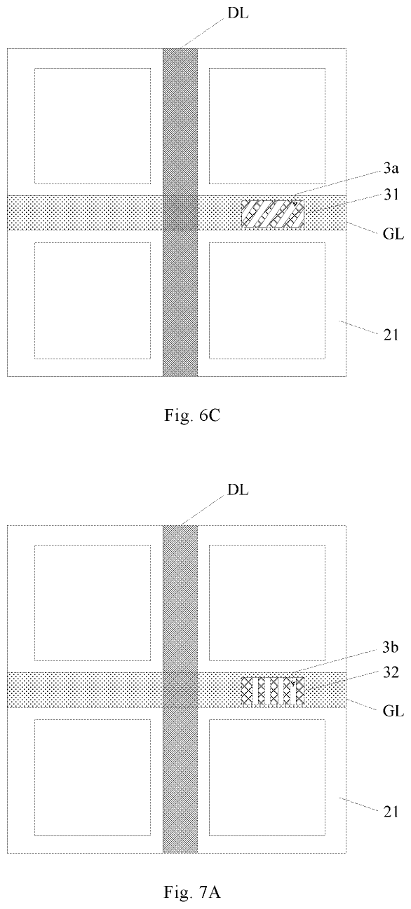

FIGS. 6A to 6C are plan structure views of an orthographic projection of a spacer pillar on an array substrate according to the present disclosure, and in some implementations, as shown in FIGS. 6A to 6C, at least one spacer pillar 31 has a first groove 3a, and an orthographic projection of the first groove 3a on the array substrate 2 runs through an orthographic projection of the spacer pillar 31 on the array substrate 2.

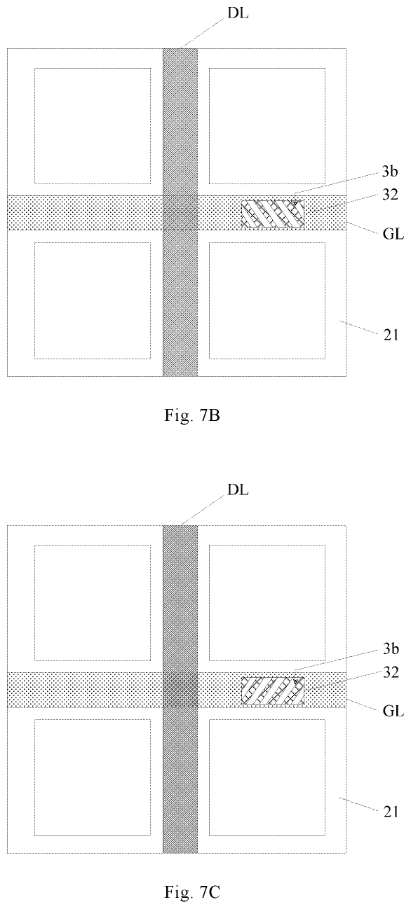

FIGS. 7A to 7C are plan structure views of an orthographic projection of a supporting part on an array substrate according to the present disclosure, and in some implementations, as shown in FIGS. 7A to 7C, at least one supporting part 32 has a second groove 3b, and an orthographic projection of the second groove 3b on the array substrate 2 runs through an orthographic projection of the supporting part 32 on the array substrate 2.

The first groove 3a may penetrate through the spacer pillar 31 in any direction, and the second groove 3b may penetrate through the supporting part 32 in any direction, and an included angle formed between a stripe pattern of the orthographic projection of the spacer pillar 31 or the supporting part 32 on the array substrate 2 and the extending direction in which the gate line GL extends may be any angle, which is not limited in the present disclosure.

In some implementations, the orthographic projection of the first groove 3a on the array substrate 2 partially overlaps the orthographic projection of the second groove 3b on the array substrate 2, that is, orthographic projections of the first groove 3a and the second groove 3b on the array substrate 2 do not completely overlap, so as to avoid a problem that the supporting structure 3 is too rigid due to complete butting of solid structures outside such grooves, and improve the stability of the supporting structure 3.

In some implementations, the orthographic projection of the first grooves 3a on the array substrate 2 is a first strip pattern, the orthographic projection of the second grooves 3b on the array substrate 2 is a second strip pattern, and the first strip pattern and the second strip pattern may extend in a same direction, i.e., in response to that the first groove 3a in the spacer pillar 31 is provided in a shape as shown in FIG. 6A, the second groove 3b in the supporting part 32 may be provided in a shape as shown in FIG. 7A; the first stripe pattern and the second stripe pattern may also extend in different directions, that is, in response to that the first groove 3a in the spacer pillar 31 is formed in the shape as shown in FIG. 6A, the orthographic projection of the second groove 3B in the supporting part 32 on the array substrate 2 may be formed in shapes as shown in FIGS. 7B and 7C, or may be formed in other stripe patterns. The first groove 3a and the second groove 3b are arranged in different directions to provide a more stable supporting structure for the display panel.

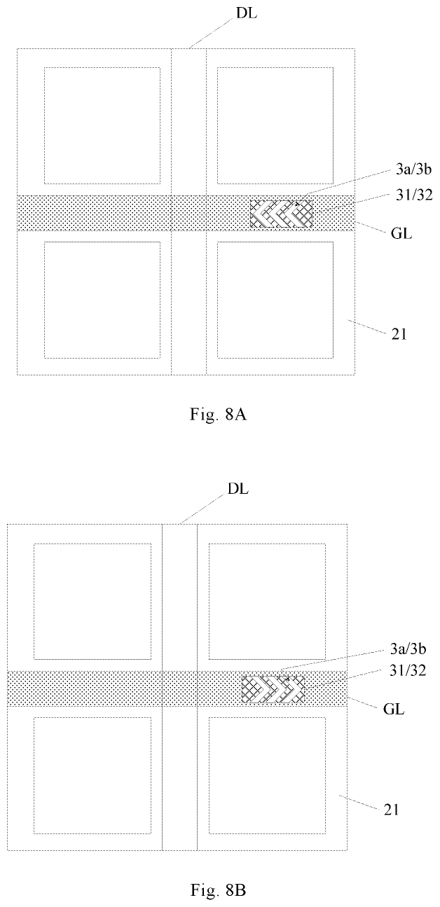

FIGS. 8A and 8B are plan structure views of an orthographic projection of a spacer pillar or a supporting part on an array substrate according to the present disclosure, and in some implementations, as shown in FIGS. 8A and 8B, an orthographic projection of at least one groove on the array substrate 2 is bent (i.e., a bent shape). The groove may be the first groove 3a of the spacer pillar 31 or the second groove 3b of the supporting part 32.

It should be noted that, in response to that the orthographic projection of any one of the spacer pillar 31 or the supporting part 32 in the supporting structure 3 on the array substrate 2 is bent (i.e., a bent shape), the orthographic projection of the other one of the spacer pillar 31 or the supporting part 32 on the array substrate 2 may be a bent shape or a strip shape, which is not limited in the present disclosure.

The above-mentioned FIGS. 3A-8B provide various ways of disposing grooves in the spacer pillar 31 and the supporting part 32, and they may be combined arbitrarily as desired, so as to achieve a higher deformation rate of the supporting structure 3, and the present disclosure is not limited to any combination.

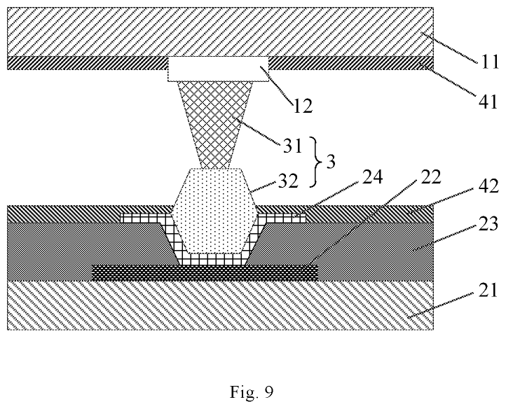

FIG. 9 is a schematic structural diagram of another display panel according to the present disclosure, in some implementations, as shown in FIG. 9, the array substrate 2 includes a thin film transistor 22, a planarization layer 23 and a pixel electrode 24 on the first base 21, the planarization layer 23 is located on a side of the thin film transistor 22 away from the first base 21, and the pixel electrode 24 is connected to a drain of the thin film transistor 22 through a via hole in the planarization layer 23; the orthographic projection of the supporting structure 3 on the first base 21 at least partially overlaps an orthographic projection of the via hole on the first base 21. The supporting part 32 is embedded in the via hole of the planarization layer 23, so that the misalignment between the supporting part 32 and the spacer pillar due to a force applied on the display panel can be effectively avoided, and the stability of the supporting structure is improved.

In addition, a longitudinal section of the supporting part 32 may have a hexagonal shape as shown in FIG. 9, or may have a rectangular, square, trapezoidal, or any other shape; a longitudinal section of the spacer pillar 31 may have a trapezoid shape as shown in FIG. 9, or may have a rectangle, a square, or any other shape, which are not limited in the present disclosure. In some implementations, an orthographic projection of an end face of the spacer pillar 31 close to the color filter substrate 1 on the color filter substrate 1 is located in an orthographic projection of an end face thereof away from the color filter substrate 1 on the color filter substrate 1, that is, the spacer pillar 31 is in an inverted trapezoidal structure; and an orthographic projection of an end face of the supporting part 32 away from the array substrate 2 is located in an orthographic projection of an end face thereof close to the array substrate 2, that is, the supporting part 32 is a positive trapezoidal structure, which can improve the stability of the supporting structure.

In some implementations, as shown in FIGS. 1, 5A, 5B, and 9, the color filter substrate 1 includes a second base 11 and a black matrix 12 on the second base 11, where the black matrix 12 is located in the space region, the spacer pillar 31 is located on a side of the black matrix 12 away from the second base 11, and an orthographic projection of the black matrix 12 on the second base 11 covers an orthographic projection of the spacer pillar 31 on the second base 11, so as to prevent the spacer pillar 31 from affecting a display effect.

In some implementations, as shown in FIG. 1, the display panel further includes a first alignment layer 41 and a second alignment layer 42, where the first alignment layer 41 is located on a side of the color filter substrate 1 facing the array substrate 2; the second alignment layer 42 is located on a side of the array substrate 2 facing the color filter substrate 1; the first/second alignment layer is configured to align liquid crystal molecules in the liquid crystal layer in a certain direction and at a certain angle. The orthographic projection of the spacer pillar 31 on the array substrate 2 is not overlapped with an orthographic projection of the first alignment layer 41 on the array substrate 2, and the orthographic projection of the supporting part 32 on the array substrate 2 is not overlapped with an orthographic projection of the second alignment layer 42 on the array substrate 2.

In a case where a force is applied on the display panel to make the spacer pillar 31 move, since the spacer pillar 31 is supported by the supporting part 32, it means that the end face of the spacer pillar 31 facing the array substrate 2 is misaligned relative to the supporting part 32, and a friction is generated between the spacer pillar 31 and the supporting parts 32, so that the second alignment layer 42 on the array substrate 2 is not to be damaged; moreover, the orthographic projection of the spacer pillar 31 on the array substrate 2 is not overlapped with the orthographic projection of the first alignment layer 41 on the array substrate 2, so that the first alignment layer 41 is not to be damaged due to the movement of the spacer pillar 31.

In some implementations, a material of the supporting structure 3 includes an elastic material, for example, a material of the supporting part 32 and/or the spacer pillar 31 in the supporting structure 3 may be any one of a resin material such as acrylic resin, high polymer polyimide, or a protective adhesive, so as to ensure the supporting effect of the supporting structure 3.

In some implementations, the material of the supporting part 32 includes an inorganic material and an organic material, for example, the inorganic material may be any one or more of SiOₓ, SiNₓ, or SiOₓN_{y}, and the organic material may include a resin-based material. A combination of the inorganic material and the organic material improves the elasticity of the supporting structure 3 and ensures the support effect of the supporting structure 3. The material of the spacer pillar 31 may include an organic material.

It should be noted that the supporting structure 3 of the display panel is relatively small in size, and although it is arranged in the space region and does not affect flowing of liquid crystal between the pixel regions, if the cell thickness of the display panel is also relatively small, a range of flowing of liquid crystal is also correspondingly reduced. In a case where the range of flowing of liquid crystal is relatively small, even if a relatively small fluctuation of liquid crystal occurs, the display effect of the display panel is easily to be affected. Therefore, by making the material of the supporting structure 3 include a relatively high elastic material, and display defects caused by the fluctuation of liquid crystal can be avoided.

An embodiment of the present disclosure further provides a display device, including the display panel described above.

The display device may be any product or component with a display function, such as electronic paper, a mobile phone, a tablet computer, a television, a display, a notebook computer, a digital photo frame, a navigator, an AR/VR display, or the like, which is not limited in the present disclosure.

It will be understood that the above embodiments are merely exemplary embodiments employed to illustrate the principles of the present disclosure, and the present disclosure is not limited thereto. It will be apparent to those skilled in the art that various changes and modifications can be made without departing from the spirit and scope of the present disclosure, and these changes and modifications are to be considered within the scope of the present disclosure.

1. A display panel, comprising: a plurality of pixel regions and a space region between adjacent pixel regions,
wherein the display panel comprises an array substrate and a color filter substrate arranged opposite to each other, and a plurality of supporting structures arranged between the array substrate and the color filter substrate, and the supporting structures are positioned in the space region;
each of the supporting structures comprises a spacer pillar arranged on the color filter substrate and a supporting part arranged on the array substrate, the spacer pillar is supported by the supporting part;
at least one of the spacer pillar or the supporting part has a groove.

2. The display panel of claim 1, wherein
the array substrate comprises a first base, a plurality of gate lines and a plurality of data lines, the gate lines and the data lines are arranged on the first base and are positioned in the space region; and
orthographic projections of the supporting structures on the first base are positioned in orthographic projections of at least ones of the gate lines or the data lines on the first base.

3. The display panel of claim 2, wherein an orthographic projection of the spacer pillar on the first base and an orthographic projection of the supporting part on the first base form a first intersection region, and an orthographic projection of each gate line on the first base and an orthographic projection of the data line corresponding to the gate line on the first base form a second intersection region;
the first intersection region at least partially overlaps the second intersection region.

4. The display panel of claim 1, wherein at least one spacer pillar has a first groove having an opening facing the supporting part.

5. The display panel of claim 4, wherein the first groove penetrates through the spacer pillar in a thickness direction of the display panel.

6. The display panel of claim 1, wherein at least one supporting part has a second groove having an opening facing the spacer pillar.

7. The display panel of claim 6, wherein the second groove penetrates through the supporting part in a thickness direction of the display panel.

8. The display panel of claim 1, wherein at least one spacer pillar has a first groove,
an orthographic projection of the first groove on the array substrate runs through an orthographic projection of the spacer pillar on the array substrate.

9. The display panel of claim 1, wherein at least one supporting part has a second groove,
an orthographic projection of the second groove on the array substrate runs through an orthographic projection of the supporting part on the array substrate.

10. The display panel of claim 1, wherein at least one spacer pillar has a first groove and at least one supporting part has a second groove,
an orthographic projection of the first groove on the array substrate is partially overlapped with an orthographic projection of the second groove on the array substrate.

11. The display panel of claim 10, wherein the orthographic projection of the first groove on the array substrate is a first stripe pattern, the orthographic projection of the second groove on the array substrate is a second stripe pattern,
the first strip pattern and the second strip pattern extend in a same direction; or, the first strip pattern and the second strip pattern extend in different directions.

12. The display panel of claim 1, wherein an orthographic projection of at least one groove on the array substrate is bent.

13. The display panel of claim 1, wherein the array substrate includes a thin film transistor, a planarization layer, and a pixel electrode disposed on a first base,
the planarization layer is positioned on a side of the thin film transistor away from the first base, and the pixel electrode is connected with a drain of the thin film transistor through a via hole in the planarization layer;
an orthographic projection of the supporting structure on the first base at least partially overlaps an orthographic projection of the via hole on the first base.

14. The display panel of claim 1, wherein the color filter substrate includes a second base and a black matrix on the second base,
the black matrix is located in the space region, the spacer pillar is located on a side of the black matrix away from the second base, an orthographic projection of the black matrix on the second base covers an orthographic projection of the spacer pillar on the second base.

15. The display panel of claim 1, further comprising: a first alignment layer and a second alignment layer,
the first alignment layer is positioned on a side, facing the array substrate, of the color filter substrate;
the second alignment layer is positioned on a side, facing the color filter substrate, of the array substrate;
an orthographic projection of the spacer pillar on the array substrate is not overlapped with an orthographic projection of the first alignment layer on the array substrate,
an orthographic projection of the supporting part on the array substrate is not overlapped with an orthographic projection of the second alignment layer on the array substrate.

16. The display panel of claim 1, wherein a material of the supporting structure comprises an elastic material.

17. The display panel of claim 1, wherein a material of the supporting part includes an inorganic material and an organic material.

18. The display panel of claim 1,
at least one spacer pillar is provided with a first groove, and a ratio of a volume of the first groove to an entire volume of the spacer pillar ranges from 10% to 90%;
at least one supporting part is provided with a second groove, and a ratio of a volume of the second groove to an entire volume of the supporting part ranges from 10% to 90%.

19. The display panel of claim 1, wherein each of the pixel regions is a rectangular region, and a ratio between a length of a short side of the rectangular region and a width of the space region ranges from 2.1:1 to 8.5:1.

20. The display panel of claim 19, wherein the length of the short side of each pixel region ranges from 4.2 μm to 17 μm.

21. (canceled)
